(19) United States
(12) Patent Application Publication
(10) Pub. No.: US 2020/0302130 A1
(43) Pub. Date: Sep. 24, 2020

(54) POWER-SAVING CARD READER DEVICE AND ACCESS CONTROL SYSTEM USING THE DEVICE

(71) Applicant: YongLin Biotech Corp., New Taipei (TW)

(72) Inventors: PENG CHANG, New Taipei (TW); WEI-WEN CHAN, New Taipei (TW)

(21) Appl. No.: 16/724,055

(22) Filed: Dec. 20, 2019

(30) Foreign Application Priority Data
Mar. 21, 2019 (TW) 108109860

(51) Int. Cl. G06K 7/10; G06F 21/44

(52) U.S. Cl. CPC G06K 7/10297; G06F 21/44

(57) ABSTRACT

A card reader device which consumes almost no power until a user's access card is presented includes a power source module, a wireless tag reader, a switch module, and a sensor. The switch module can electrically connect and disconnect to the power source module and the wireless tag reader. The sensor can detect a change in a magnetic field caused by proximity of the access card. When the card reader device is not in use, the switch module is turned off, and the power source module does not provide power to the wireless tag reader. When the change in the magnetic field is detected by the sensor, a signal from the sensor turns on the switch module, and the power source module provides power to the wireless tag reader. A related access system employing the card reader device is also disclosed.

### FIELD

The subject matter herein generally relates to efficient power distribution.

### BACKGROUND

A traditional access control system can adopt radio frequency identification (RFID) technology. An identifier in an access card is energized and responds to an energy input by broadcasting, a broadcast response is received and demodulated by a card reader, and the legality and validity of the access card are thereby determined. Such traditional access control system needs to continuously supply power to the card reader for instant sensor recognition of the access card. The continuous power supply from the traditional access control system to the card reader can lead to a large power consumption and an additional cost.

Therefore, there is a room for improvement.

### BRIEF DESCRIPTION OF THE DRAWING

Implementations of the present disclosure will now be described, by way of embodiments, with reference to the attached figure.

FIG. 1 is a diagram of an embodiment of an access control system utilizing a card reader.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

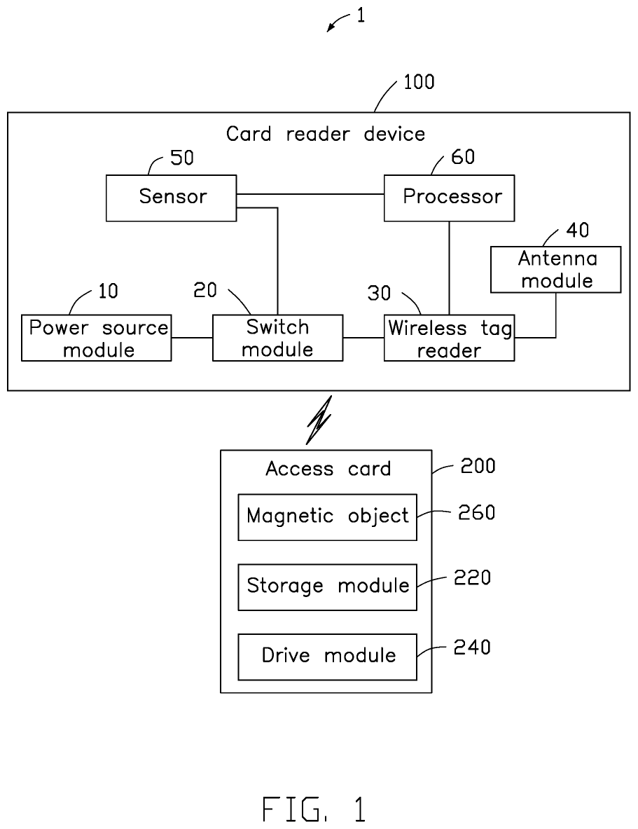

FIG. 1 illustrates an access control system 1 in accordance with an embodiment of the present disclosure.

The access control system 1 can include a card reader device 100 and an access card 200. In the embodiment, the access card 200 has an identifier.

In at least one embodiment, the identifier in the access card 200 may be a radio frequency identification (RFID) technology. The card reader device 100 transmits a radio frequency (RF) signal, receives and demodulates a response of the identifier of the access card 200, and determines the legality and validity of the access card 200.

In at least one embodiment, the access control system 1 can be applied to a channel port. The card reader device 100 can be mounted on a door or a wall of a passage opening. The access card 200 is carried by a user. The card reader device 100 is configured to determine the legality and validity of the access card 200, and determine whether to open the channel port to allow access.

In at least one embodiment, the card reader device 100 includes a power source module 10, a switch module 20, a wireless tag reader 30, an antenna module 40, a sensor 50, and a processor 60. In one embodiment, the wireless tag reader 30 may be an RFID reader.

In at least one embodiment, the power source module 10 is electrically connected to the wireless tag reader 30 through the switch module 20. The wireless tag reader 30 is electrically connected to the antenna module 40.

When the switch module 20 is turned on, the power source module 10 is connected to the wireless tag reader 30 and the antenna module 40 to supply power to the card reader device 100. When the switch module 20 is turned off, the power source module 10 is disconnected from the wireless tag reader 30 and the antenna module 40, and the card reader device 100 receives no power.

In at least one embodiment, the power source module 10 is electrically connected to an alternating current (AC) power supply (not shown), to provide power requirements for the operation of the card reader device 100.

In another embodiment, the power source module 10 is equipped with a battery or a super capacitor, to provide power requirements for the operation of the card reader device 100.

In at least one embodiment, the power source module 10 can be a power output device in any form to provide a stable power for the operation of the card reader device 100.

In at least one embodiment, the switch module 20 can be a digital switch. The switch module 20 is turned off by a logic-low voltage. The switch module 20 is turned on by a logic-high voltage.

In at least one embodiment, when the wireless tag reader 30 receives power, the wireless tag reader 30 transmits an RF signal through the antenna module 40, to drive the access card 200. The wireless tag reader 30 further receives the response of the identifier, transmitted by the access card 200, and the antenna module 40 receives the response and demodulates the response.

In at least one embodiment, the antenna module 40 has a radiation range. When the access card 200 enters the radiation range, a radio frequency signal is transmitted by the antenna module 40, and the antenna module 40 can receive the response from the identifier of the access card 200. Within the radiation range, the card reader device 100 can establish a wireless communication connection with the access card 200.

In another embodiment, the wireless tag reader 30 can be other types of wireless tag readers. The wireless tag reader 30 can read the identifier of the access card 200 through protocols such as WI-FI or BLUETOOTH.

In at least one embodiment, the sensor 50 is configured to detect a magnetic object (such as a magnetic component) and thereby transmit a detection signal.

In at least one embodiment, the sensor 50 can be, but is not limited to, a Hall sensor. When the magnetic object is close to the sensor 50, the sensor 50 detects a change in a magnetic field. An increase in magnetic flux is detected by the sensor 50, and the detection signal is output by the sensor 50. In the embodiment, the detection signal can be a logic-high voltage signal.

In at least one embodiment, the sensor 50 has a detection range. When the magnetic object enters the detection range, the sensor 50 detects the change in the magnetic field.

In at least one embodiment, the switch module 20 and the processor 60 are electrically connected to the sensor 50, and the sensor 50 outputs the detection signal to the switch module 20 and the processor 60.

In at least one embodiment, the processor 60 is electrically connected to the wireless tag reader 30. The processor 60 is configured to determine the legality and validity of the identifier response of the access card 200 received by the wireless tag reader 30. The card reader device 100 can store a default value.

In at least one embodiment, the processor 60 can be a microcontroller unit (MCU).

The processor 60 compares the identifier response of the access card 200 with the default value stored in the card reader device 100. When the identifier response of the access card 200 matches the default value stored in the card reader device 100, the processor 60 can determine that the access card 200 is legal.

When the processor 60 determines that the access card 200 is legal, the processor 60 can confirm the identity of the access card 200 to further control the action of the channel port, such as opening the door of the channel port.

In at least one embodiment, the processor 60 has an enable terminal (not shown). When the enable terminal of the processor 60 receives a logic-high voltage, the processor 60 is activated, otherwise, the processor 60 is in a sleep state.

In at least one embodiment, the access card 200 can include a storage module 220, a drive module 240, and a magnetic object 260.

The storage module 220 stores the response of the identifier of the access card 200. In at least one embodiment, the identifier response of the access card 200 is unique and identifies the access card 200.

The drive module 240 is configured to be driven when receiving the RF signal transmitted by the card reader device 100, and transmits the response of the identifier of the access card 200 to the card reader device 100.

The magnetic object 260 can be disposed in a housing (not shown) of the access card 200. In another embodiment, the magnetic object 260 can also be exposed outside the housing of the access card 200.

In at least one embodiment, the switch module 20 is turned off if the enable terminal of the processor 60 is not receiving the logic-high voltage and the power source module 10 is disconnected from the wireless tag reader 30. When power is not supplied to the card reader device 100, the card reader device 100 achieves power saving state.

In at least one embodiment, when a user uses the access card 200 for identity verification, the access card 200 is physically close to the card reader device 100, and the magnetic object 260 of the access card 200 enters the detection range of the sensor 50 of the card reader device 100. The sensor 50 detects the change in the magnetic field. When the detected magnetic flux increases, the detection signal is output to the switch module 20 and the processor 60. In the embodiment, the detection signal is a logic-high voltage signal.

The switch module 20 is turned on according to the logic-high voltage signal. The power source module 10 supplies power to the wireless tag reader 30, and the wireless tag reader 30 transmits the RF signal through the antenna module 40. The drive module 240 of the access card 200 receives the RF signal and is driven to respond, broadcasting the response to the card reader device 100. The wireless tag reader 30 receives the response of the access card 200 through the antenna module 40, demodulates the same, and transmits result of demodulation to the processor 60. The processor 60 is activated when the processor 60 receives the logic-high voltage signal. The processor 60 compares the response of identifier of the access card 200 with the default value stored in the card reader device 100 to determine the legality and validity of the access card 200.

When the card reader device 100 is not in use, the sensor 50 does not detect any change in the magnetic field and the power source module 10 does not supply power to the wireless tag reader 30. The card reader device 100 achieves a power saving state. When the access card 200 is brought close to the card reader device 100, the sensor 50 detects the change in the magnetic field and controls the power source module 10 to supply power to the wireless tag reader 30. The card reader device 100 can authenticate the access card 200.

Therefore, although fully operational, the card reader device 100 can effectively save energy, reduce costs, and meet the needs of green environmental protection.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A card reader device configured for authenticating an access card, comprising:
a power source module;
a wireless tag reader;
a switch module electrically connecting or disconnecting to the power source module and the wireless tag reader;
a sensor electrically connecting to the switch module, and detecting a change in a magnetic field of the access card;
wherein when the card reader device is idle, the switch module is turned off, the power source module does not supply power to the wireless tag reader; and
wherein when the sensor detects the change in the magnetic field, the sensor outputs a detection signal to turn on the switch module, and the power source module supplies power to the wireless tag reader.

2. The card reader device of claim 1, wherein the power source module is disconnected from the wireless tag reader when the switch module is turned off, and the power source module does not supply power to the wireless tag reader; the power source module is electrically connected to the wireless tag reader when the switch module is turned on, and the power source module supplies power to the wireless tag reader.

3. The card reader device of claim 2, wherein the switch module is a digital switch, the switch module is turned off by a logic-low voltage, and the switch module is turned on by a logic-high voltage.

4. The card reader device of claim 3, further comprising an antenna module, the antenna module is electrically connected to the wireless tag reader; when the wireless tag reader receives the power supply from the power source module, the wireless tag reader transmits an radio frequency (RF) signal and receives a response of an identifier of the access card through the antenna module.

5. The card reader device of claim 4, wherein the sensor detects a magnetic object; when the magnetic object is close to the sensor, the sensor detects an increase in magnetic flux and outputs the detection signal, and the detection signal is a logic-high voltage signal.

6. The card reader device of claim 1, wherein the sensor is a hall sensor.

7. The card reader device of claim 5, further comprising a processor, wherein the sensor and the wireless tag reader are electrically connected to the processor, and the processor determines the legality and validity of the response of the identifier of the access card received by the wireless tag reader.

8. The card reader device of claim 7, wherein the processor is activated when the processor receives the detection signal; and wherein the card reader device stores a default value, and the processor compares the response of the identifier of the access card with the default value, when the response of the identifier of the access card matches the default value, the processor determines the access card is legal, and authenticates the access card.

9. The card reader device of claim 4, wherein the wireless tag reader is a radio frequency identification (RFID) reader, and the wireless tag reader receives the response of the identifier of the access card through RFID technology.

10. The card reader device of claim 7, wherein the processor is a microcontroller unit (MCU).

11. An access control system comprising:
an access card comprising a magnetic object; and
a card reader device comprising:
a power source module;
a wireless tag reader;
a switch module electrically connecting or disconnecting to the power source module and the wireless tag reader;
a sensor electrically connecting to the switch module, and detecting a change in a magnetic field of the magnetic object;
wherein when the card reader device is idle, the switch module is turned off, the power source module does not supply power to the wireless tag reader; and
wherein when the sensor detects the change in the magnetic field, the sensor outputs a detection signal to turn on the switch module, and the power source module supplies power to the wireless tag reader.

12. The access control system of claim 11, wherein the power source module is disconnected from the wireless tag reader when the switch module is turned off, and the power source module does not supply power to the wireless tag reader; the power source module is electrically connected to the wireless tag reader when the switch module is turned on, and the power source module supplies power to the wireless tag reader.

13. The access control system of claim 12, wherein the switch module is a digital switch, the switch module is turned off by a logic-low voltage, and the switch module is turned on by a logic-high voltage.

14. The access control system of claim 13, further comprising an antenna module, the antenna module is electrically connected to the wireless tag reader; when the wireless tag reader receives the power supply from the power source module, the wireless tag reader transmits an radio frequency (RF) signal and receives a response of an identifier of the access card through the antenna module.

15. The access control system of claim 14, wherein the sensor detects the magnetic object; when the magnetic object is close to the sensor, the sensor detects an increase in magnetic flux and outputs the detection signal, and the detection signal is a logic-high voltage signal.

16. The access control system of claim 11, wherein the sensor is a hall sensor.

17. The access control system of claim 15, further comprising a processor, wherein the sensor and the wireless tag reader are electrically connected to the processor, and the processor determines the legality and validity of the response of the identifier of the access card received by the wireless tag reader.

18. The access control system of claim 17, wherein the processor is activated when the processor receives the detection signal; and wherein the card reader device stores a default value, and the processor compares the response of the identifier of the access card with the default value, when the response of the identifier of the access card matches the default value, the processor determines the access card is legal, and authenticates the access card.

19. The access control system of claim 14, wherein the wireless tag reader is a radio frequency identification (RFID) reader, and the wireless tag reader receives the response of the identifier of the access card through RFID technology.

20. The access control system of claim 17, wherein the processor is a microcontroller unit (MCU).
